(19) United States
(12) Patent Application Publication
(10) Pub. No.: US 2017/0054534 A1
(43) Pub. Date: Feb. 23, 2017

(54) Robust Mobility Measurements and Inter-Cell Coordination in MMwave Small Cell

(71) Applicant: MEDIATEK INC., Hsinchu (TW)

(72) Inventors: Aimin Justin Sang, San Diego, CA (US); Chia-Hao Yu, Yilan County (TW); Yuanyuan Zhang, Beijing (CN); Jiann-Ching Guey, Hsinchu City (TW)

(21) Appl. No.: 15/345,720

(22) Filed: Nov. 8, 2016

Related U.S. Application Data
(63) Continuation of application No. PCT/CN2015/077647, filed on Apr. 28, 2015.

(51) Int. Cl. H04L 5/00; H04W 72/08; H04W 36/00; H04W 72/04

(52) U.S. Cl. CPC H04L 5/0032; H04W 72/048; H04L 5/005; H04W 72/082; H04W 72/046; H04W 36/0088

(57) ABSTRACT

Inter-cell coordination and beam-aware scanning with end-to-end UE-BS signaling enhancements for robust HO trigger in a beamforming mmWave network is proposed. From the network and the base station perspective, inter-BS control beam coordination is performed, coupled with neighbor-cell information advertisement to facilitate UE-side beam-aware scanning. Inter-BS CB coordination enables a variety of network planning, pre-determined or random, enhanced with UE-reports and dynamic re-coordination to minimize inter-cell interference. From UE perspective, by utilizing the advertised CB information, UE can learn serving cell and neighbor cell CB pattern for beam-aware scanning. Beam-aware scanning enables power saving fast scanning at the UE with beam-aware HO measurement of neighboring and target cells, which reduces HO latency and avoids unnecessary HO.

### CROSS REFERENCE TO RELATED APPLICATIONS

This application is filed under 35 U.S.C. §111(a) and is based on and hereby claims priority under 35 U.S.C. §120 and §365(c) from International Application No. PCT/CN2015/077647, with an international filing date of Apr. 28, 2015. This application is a continuation of International Application No. PCT/CN2015/077647. International Application No. PCT/CN2015/077647 is pending as of the filing date of this application, and the United States is a designated state in International Application No. PCT/CN2015/077647. The disclosure of each of the foregoing documents is incorporated herein by reference.

### TECHNICAL FIELD

The disclosed embodiments relate generally to wireless communication, and, more particularly, to mobility measurement and inter-cell coordination in a Millimeter Wave (mmW) beamforming system.

### BACKGROUND

The bandwidth shortage increasingly experienced by mobile carriers has motivated the exploration of the underutilized Millimeter Wave (mmWave) frequency spectrum between 4G and 300G Hz for the next generation broadband cellular communication networks. The available spectrum of mmWave band is two hundred times greater than the conventional cellular system. The mmWave wireless network uses directional communications with narrow beams and can support multi-gigabit data rate. The underutilized bandwidth of the mmWave spectrum has wavelengths ranging from 1 mm to 100 mm. The very small wavelengths of the mmWave spectrum enable large number of miniaturized antennas to be placed in a small area. Such miniaturized antenna system can produce high beamforming gains through electrically steerable arrays generating directional transmissions.

In LTE systems, many handover (HO) scenarios and schemes exist, including intra macro-cell HO, intra smallcell HO, and Heterogeneous Network (HetNet) and inter-system HO. Different mobility actions in different HO scenarios are involved. Those actions include connected-mode mobility measurement and report for HO trigger, radio link failure (RLF) detection and UE-based mobility, cell selection and S criteria with stored-information, and cell reselection and R criteria for UE-based idle-mode mobility. For smallcell mobility, however, the smaller cell size introduces more frequency HO measurements, higher interference, higher signaling overhead and power consumption for mobility UEs.

The existing LTE mobility is complex but based on omni-directional antenna without beamforming. In general, LTE smallcell mobility can be used as the baseline for a standalone mmWave smallcell. However, the heavy reliance on directional transmissions and the vulnerability of the propagation environment present particular challenges arise from channel characteristics and beamforming in mmWave small cells. For example, directional antenna and beamforming tracking makes mobility even harder and less smooth, which may require more intelligent measurement at UE to offset the intermittent links. Multiple levels of beams, multiple beams per level, and multiple TDM beamformed control beams per cell for UE to scan, which may require signaling enhancements between the network and UE for accurate power-saving multi-cell scanning. Small channel coherent time and more dynamic channel due to higher frequency and beam misalignment/switching, which may require more dynamic connectivity and cell-edge interference to be compensated by inter-BS and BS-UE coordination.

A solution for robust mobility measurement, signaling, and inter-BS coordination in standalone, low-mobility mmWave smallcell systems is sought.

### SUMMARY

Inter-cell coordination and beam-aware scanning with end-to-end UE-BS signaling enhancements for robust HO trigger in a beamformed mmWave network is proposed. From the network and the base station perspective, inter-BS control beam coordination is performed, coupled with neighbor-cell information advertisement to facilitate UE-side beam-aware scanning. Inter-BS CB coordination enables a variety of network planning, pre-determined or random, enhanced with UE-reports and dynamic re-coordination to minimize inter-cell interference. From UE perspective, by utilizing the advertised CB information, UE can learn serving cell and neighbor cell CB pattern for beam-aware scanning. Beam-aware scanning enables power saving fast scanning at the UE with beam-aware HO measurement of neighboring and target cells, which reduces HO latency and avoids unnecessary HO.

In one novel aspect, a method of providing inter-BS control beam coordination and neighbor cell information advertisement in a beamformed mmWave smallcell is provided. A serving base station receives control beam information of a neighbor base station in the beamformed mmWave smallcell. The CB information comprises a CB period, CB patterns, and CB sweeping order of a collection of control beams. The serving BS determines CB configuration by coordinating with the neighbor BS. Each control beam is configured with a set of periodically allocated resource blocks and a set of beamforming weights. Finally, the serving BS then transmits the CB configuration of the serving BS and the CB information of the neighbor BS to a plurality of user equipments (UEs).

In another novel aspect, a method of beam-aware scanning and measurement reporting in a beamformed mmWave smallcell is provided. A user equipment (UE) receives control beam information from a serving base station in the beamformed mmWave smallcell. The CB information comprises a CB period, CB patterns, and a CB sweeping order of a collection of control beams of the serving BS and a neighbor BS. The UE performs beam-aware scanning over all control beams during advertised CB periods. Finally, the UE transmits a measurement report to the serving BS. The measurement report comprises detectable CB coverage information.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a beamforming mmWave mobile communication network having an end-to-end robust measurements scheme in accordance with one novel aspect.

FIG. 2 is a simplified block diagram of a base station and a user equipment that carry certain embodiments of the present invention.

FIG. 3 illustrates an example of control beams in a beamforming mmWave smallcell system.

FIG. 4 illustrates an example of beam alignment in a beamforming mmWave smallcell system.

FIG. 5 illustrates one embodiment of inter-BS control beam coordination.

FIG. 6 illustrates another embodiment of inter-BS control beam coordination.

FIG. 7 illustrates FDM-separated control beams and/or CDM-separated control beams.

FIG. 8 illustrates reference signals carried on control beams are FDM-separated or CDM-separated.

FIG. 9 illustrates the concept of inter-BS control beam coordination coupled with neighbor cell information advertisement.

FIG. 10 is a signaling flow chart of supporting inter-BS control beam re-coordination.

FIG. 11 illustrate an example of inter-BS control beam re-coordination.

FIG. 12 is another signaling flow chart of supporting inter-BS control beam re-coordination.

FIG. 13 illustrate one embodiment of staggered BS control beam sweeping direction and order.

FIG. 14 illustrates UE behavior upon neighbor cell information acquisition.

FIG. 15 illustrates one embodiment of beam-aware scanning and measurement reporting after inter-BS control beam coordination and receiving neighbor cell information advertisement.

FIG. 16 is a flow chart of a method of providing inter-BS control beam coordination and neighbor cell information advertisement in a beamformed mmWave smallcell in accordance with one novel aspect.

FIG. 17 is a flow chart of a method of beam-aware scanning and measurement reporting in a beamformed mmWave smallcell in accordance with one novel aspect.

### DETAILED DESCRIPTION

Reference will now be made in detail to some embodiments of the invention, examples of which are illustrated in the accompanying drawings.

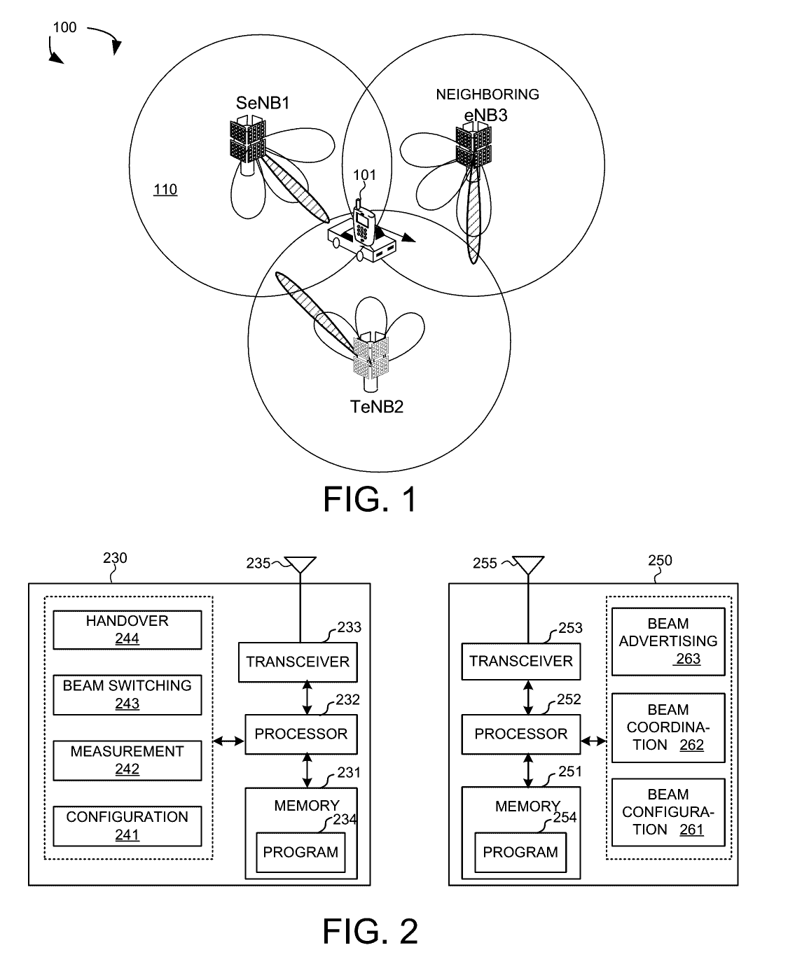

FIG. 1 illustrates a beamforming Millimeter Wave (mmWave) mobile communication network 100 having an end-to-end robust measurements scheme in accordance with one novel aspect. Beamforming mmWave mobile communication network 100 comprises a plurality of base stations (eNBs) including a source eNodeB SeNB1, a target eNodeB TeNB2, and a neighbor eNodeB eNB3 serving a plurality of smallcells. User equipment UE 101 is initially served by source base station SeNB1 in smallcell 110. In LTE systems, many handover (HO) scenarios and schemes exist, including intra macro-cell HO, intra smallcell HO, and Heterogeneous Network (HetNet) and inter-system HO. In general, LTE smallcell mobility can be used as the baseline for a standalone mmWave smallcell. However, the heavy reliance on directional transmissions and the vulnerability of the propagation environment present particular challenges arise from channel characteristics and beamforming in mmWave smallcells.

In accordance with one novel aspect, a solution of inter-cell coordination and beam-aware scanning with end-to-end UE-BS signaling enhancements is proposed for robust handover (HO) trigger. The purpose is to design an efficient end-to-end solution to mobility measurement and robust measurement metrics for HO trigger in beamformed mmWave systems. BSs coordinate control beam transmission, with neighbor-cell control beam patterns advertised to UE. Assisted with beamforming-specific signaling information, UE can perform robust beam-aware scanning to avoid unnecessary Hos and power consumption. Automated coordination among neighboring cells or UE-BS enables fast mobility measurement and avoids excessive cell edge interference or cell planning.

FIG. 2 is a simplified block diagram of a base station eNB 250 and a user equipment UE 230 that carry certain embodiments of the present invention. UE 230 has an antenna 235, which transmits and receives radio signals. A RF transceiver module 233, coupled with the antenna, receives RF signals from antenna 235, converts them to baseband signals and sends them to processor 232. RF transceiver 233 also converts received baseband signals from processor 232, converts them to RF signals, and sends out to antenna 235. Processor 232 processes the received baseband signals and invokes different functional modules to perform features in UE 230. Memory 231 stores program instructions and data 234 to control the operations of UE 230. UE 230 also includes multiple function modules that carry out different tasks in accordance with embodiments of the current invention. A configuration module 241 acquires beam configuration information of the serving cell as well as neighboring cells, measurement module 242 performs beam-aware scanning based on the beam configuration information, beam-switching module 243 perform beam-switching within the same serving cell, and handover module 244 performs handover from a source cell to a target cell based on the measurement results.

Similarly, eNB 250 has an antenna 255, which transmits and receives radio signals. A RF transceiver module 253, coupled with the antenna, receives RF signals from antenna 255, converts them to baseband signals, and sends them to processor 252. RF transceiver 153 also converts received baseband signals from processor 252, converts them to RF signals, and sends out to antenna 255. Processor 252 processes the received baseband signals and invokes different functional modules to perform features in eNB 250. Memory 251 stores program instructions and data 254 to control the operations of eNB 250. eNB 250 also includes function modules that carry out different tasks in accordance with embodiments of the current invention. Beam configuration module 261 configures different levels of control beams and data beams for control and data transmission, beam coordination module 262 coordinates beam configuration with neighbor cells to reduce mutual interference, and beam advertising module 263 signals control beam configuration to enable beam-aware scanning at the UE for efficient measurement.

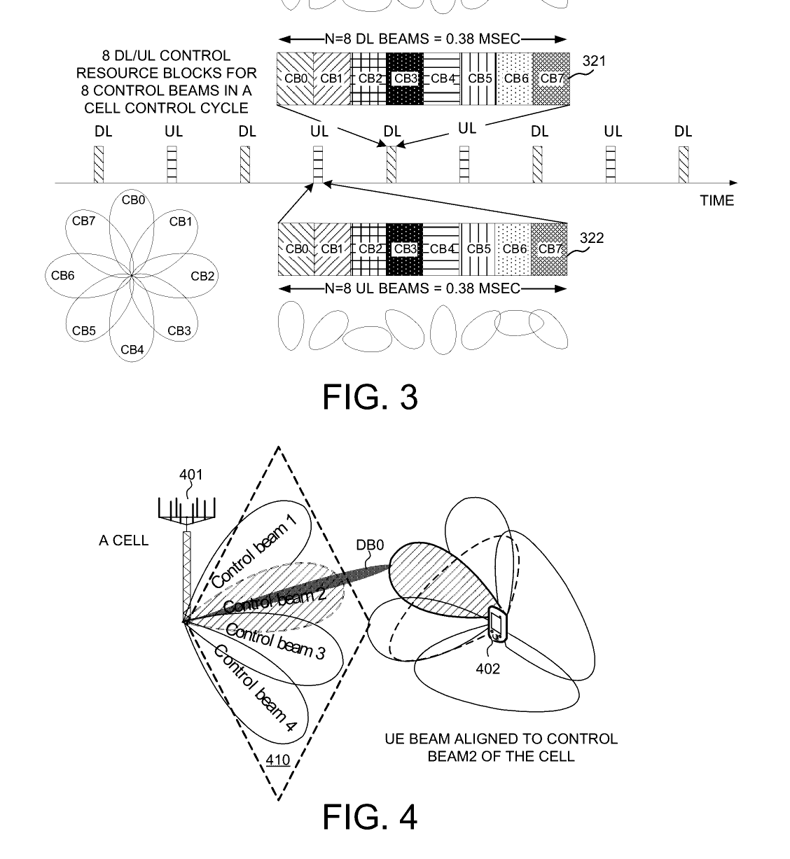

FIG. 3 illustrates an example of control beams in a beamforming mmWave smallcell system. A base station is directionally configured with multiple cells, and each cell is covered by a set of coarse TX/RX control beams. In one embodiment, a serving cell is covered by eight control beams CB0 to CB7. Each control beam comprises a set of downlink resource blocks, a set of uplink resource blocks, and a set of associated beamforming weights with moderate beamforming gain. In the example of FIG. 3, different periodically configured control beams are time division multiplexed (TDM) in time domain. A downlink subframe 321 has eight DL control beams occupying a total of 0.38 msec. An uplink subframe 322 has eight UL control beams occupying a total of 0.38 msec. The interval between the DL subframe and the UL subframe is 2.5 msec. The set of control beams are lower-level control beams that provide low rate control signaling to facilitate high rate data communication on higher-level data beams. Each control beam broadcasts minimum amount of cell-specific and beam-specific information similar to SIB or MIB in LTE. The control beam and data beam architecture provides a robust control-signaling scheme to facilitate the beamforming operation in mmWave cellular network systems.

FIG. 4 illustrates an example of beam alignment in a beamforming mmWave smallcell system. In the example of FIG. 4, base station BS 401 is configured with cell 410, which is covered by four coarse TX/RX control beams CB1 to CB4. In addition, each control beam is covered by a plurality of fine data beams. The set of control beams are lower-level control beams that provide low rate control signaling to facilitate high rate data communication on higher-level data beams. For example, UE 402 is aligned to control beam CB2 of the cell. UE 402 performs time and frequency synchronization with BS 401 using the selected control beam CB2 and receives broadcasted cell-specific and beam-specific information via CB2. Upon establishing a dedicated connection with BS 401, a dedicated data beam DBO is then used for data communication.

In such beamforming mmWave smallcell systems, directional antenna and beamforming tracking makes mobility even harder and less smooth, which may require intelligent measurement at UE to offset the intermittent links. Multiple levels of beams, multiple beams per level, and multiple TDM beamformed control beams per cell for UE to scan, which may require signaling enhancements between the network and UE for accurate power-saving multi-cell scanning. Small channel coherent time and more dynamic channel due to higher frequency and beam misalignment or switching, which may require more dynamic connectivity and cell-edge interference to be compensated by inter-BS and BS-UE coordination.

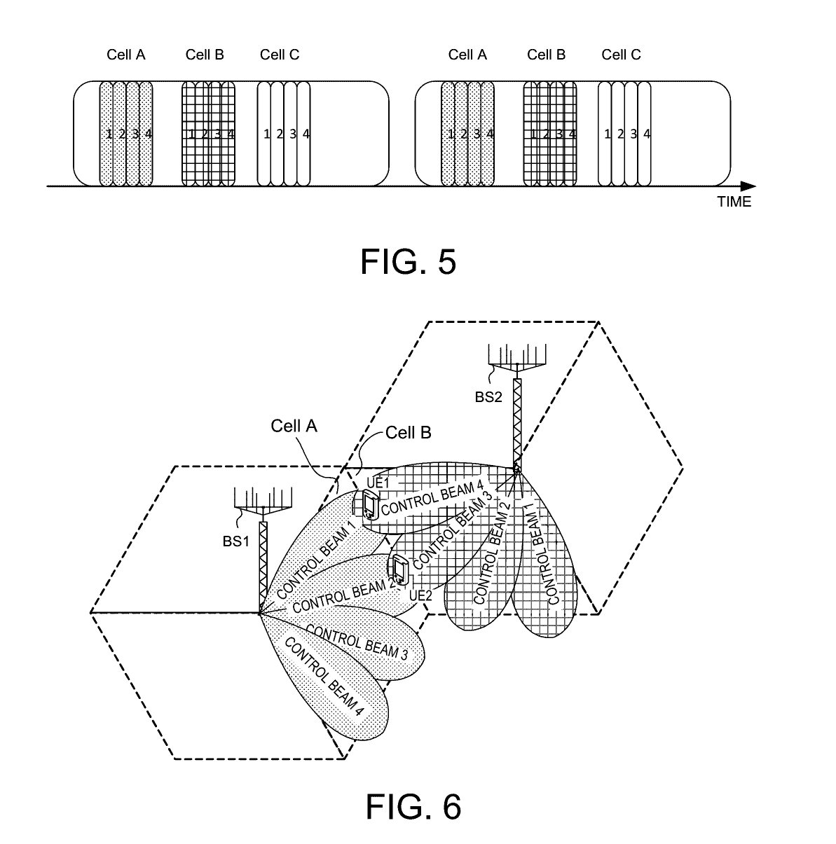

FIG. 5 illustrates one embodiment of inter-BS control beam coordination. There are different multiplexing schemes can be applied for control beam coordination among neighboring cells, e.g., Time Division Multiplexing (TDM), Spatial Division Multiplexing, Frequency Division Multiplexing, and Code Division Multiplexing. Taking the TDM-separated control beam (CB) transmission in each cell for example, different cells may interfere with each other at UE side, causing high UE efforts for monitoring if not properly planned (pre-determined) or (dynamically) coordinated. In general, neighbor-cell CB transmission with overlapping CB periods may cause mutual interference if they have overlapped spatial coverage. In the example of FIG. 5, three cells Cell A, Cell B, and Cell C belong to different base stations, each cell is covered by four control beams CB1 to CB4. The base stations are coordinated to achieve asynchronous neighbor-cell CB transmission, which has no overlapping CB periods. Asynchronous neighbor-cell CB transmission prevents mutual interference at the cost of higher UE efforts for monitoring, because the asynchronous CB transmission requires long scanning time and more power consumption at UE side. For TDM with overlapping CB periods, then other separations, e.g., FDM, CDM, or SDM may be applied among neighboring cells to avoid or reduce inter-cell interference.

FIG. 6 illustrates another embodiment of inter-BS control beam coordination. In the example of FIG. 6, Cell A is served by base station BS1 and Cell B is served by base station BS2. Both Cell A and Cell B are covered by four control beams CB1 to CB4. Cell A has a time-domain sweeping for CB transmission, while Cell B also has a time-domain sweeping for CB transmission. Cell A and Cell B may have the same sweeping time and order. In general, synchronous control beam transmission has overlapping CB periods among neighbor cells, hence UE1 and UE2 may suffer from inter-cell interference. However, if the synchronous control beam transmission has non-overlapping spatial coverage, then inter-cell interference can be reduced. More specifically, the control beam pattern (e.g., the sweeping period and order) among neighbor cells can be coordinated to achieve SDM with non-overlapping spatial coverage of the CB transmission.

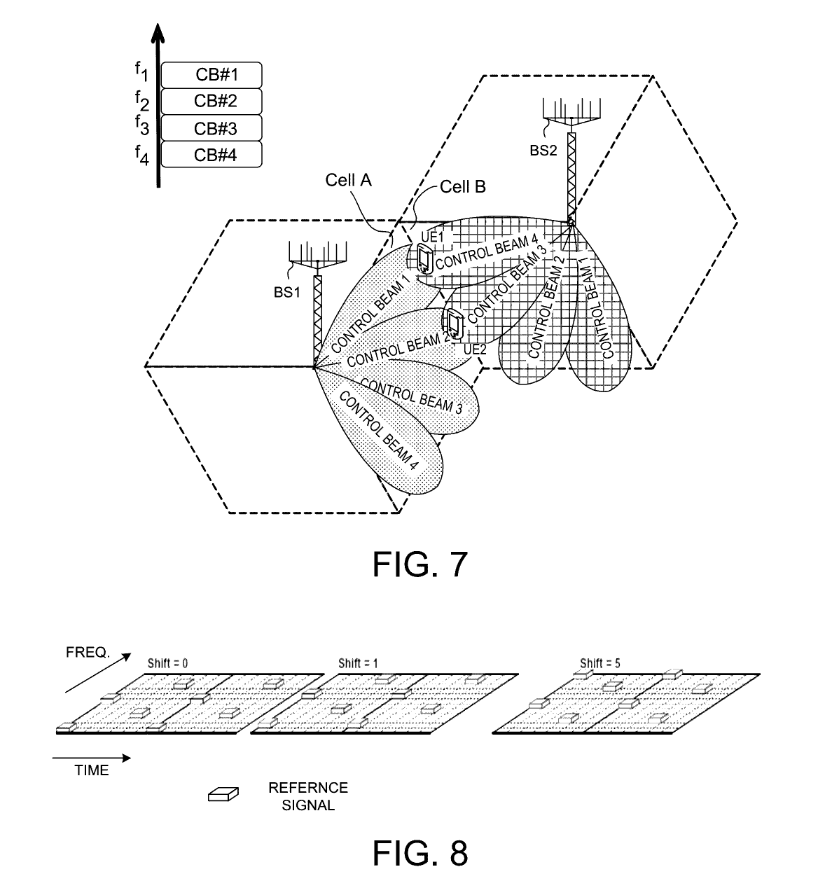

FIG. 7 illustrates FDM-separated control beams and/or CDM-separated control beams. In case when intra-cell control beams are FDM-separated and/or CDM-separated, mutual interference remains as long as control beam transmission of neighbor cells take place in the same physical resources. In the example of FIG. 7, Cell A is served by base station BS1 and Cell B is served by base station BS2. Both Cell A and Cell B are covered by four control beams CB1 to CB4. Cell A has a time-domain sweeping for CB transmission, while Cell B also has a time-domain sweeping for CB transmission. UE1 is under mutual butt or space and bold interference of (Cell A, CB#1) and (Cell B, CB#1) if they are transmitted at the same time. This is because the control beams are FDM-separated, and both CB#1 of Cell A and CB#1 of Cell B share the same time-frequency resources if they are transmitted at the same time. Therefore, inter-BS TDM and SDM control beam coordination becomes important to reduce the inter-cell interference. In addition, any combination of FDM and CDM scheme may be applied as well.

FIG. 8 illustrates reference signals carried on control beams that are FDM-separated or CDM-separated. Reference signals (RSs) are used for UE synchronization, measurement, etc. FDM-separated or CDM-separated RSs cause no or small mutual interference, thus is beneficial for UE measurement. As illustrated in FIG. 8, different frequency shifts for RSs on control beams of different neighboring cells are applied. For the remaining control beams of neighboring cells with RSs carried on control beams occupy the same physical resource and code, inter-BS coordination can be applied for avoiding mutual interference. In addition, frequency and code separation among neighboring cells can be coordinated by utilizing approaches outlined below.

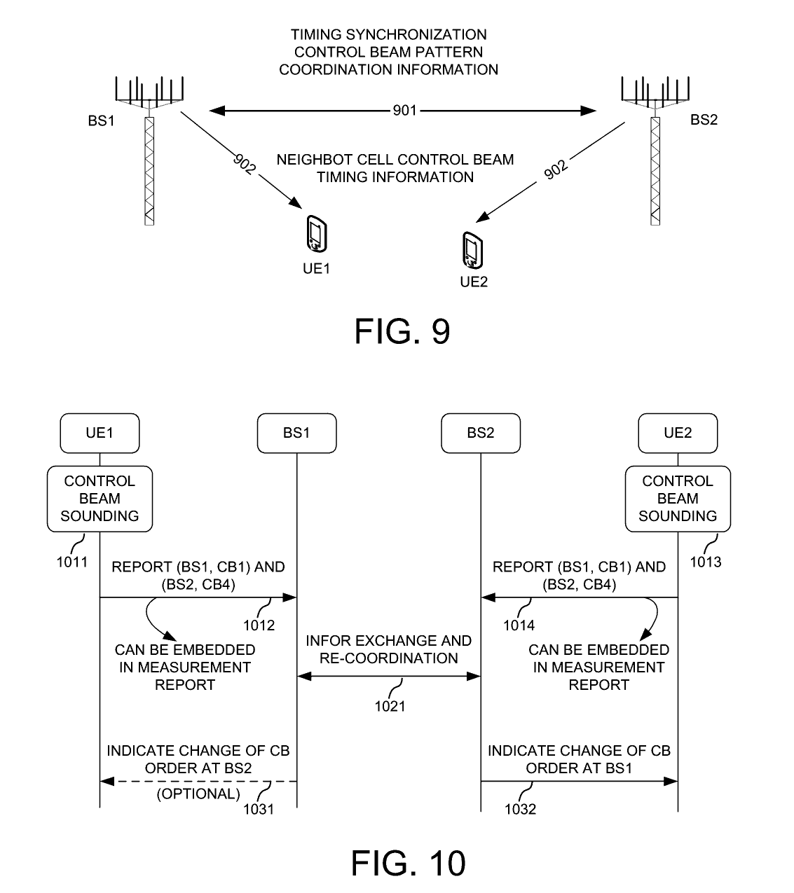

FIG. 9 illustrates the concept of inter-BS control beam coordination coupled with neighbor cell information advertisement in a beamforming mmWave network 900 having a first base station BS1 and a second base station BS2. Using TDM for example, prior CB knowledge exchange between BSs are applied for inter-BS coordination, and coordinated CB information is then indicated to UEs by Neighbor Advertisement. Depending on backhaul communications and operator policies, a neighboring mmWave cell may be synchronous or asynchronous to a serving mmWave cell. For asynchronous neighboring cells, their CB transmission time periods can be different. For synchronous neighboring cells, their CB transmission time periods can be overlapping (e.g., with reference to GPS). In general, for synchronous CB transmission, the CB sweeping order among different neighboring cells shall be coordinated to achieve non-overlapping spatial coverage (e.g., SDM). Furthermore, FDM and/or CDM can be combined with TDM/SDM schemes to reduce inter-cell interference.

In a first step 901, individual BSs (BS1 and BS2) can learn this timing synchronicity information of their neighboring cells via a BS-BS signaling, from operators, or following some pre-determined or otherwise random pattern per network planning. A new or existing BS can also follow operator policies to coordinate their pre-determined or random CB pattern that includes periodicity, synchronicity, and sweeping order of control beams. In a second step 902, the serving BS can advertise such neighboring cell information to its serving UEs. For example, BS1 can advertise CB information of BS2 to UE1, and BS2 can advertise CB information of BS1 to UE2. Such advertisement can reduce the scanning effort on locating the proper neighbor-cell control beams.

FIG. 10 is a signaling flow chart of supporting inter-BS control beam re-coordination. Using TDM for example, the inter-BS CB pattern coordination can be re-coordinated or refined dynamically based on UE reports. In general, UE knows better its local inter-cell interference than BS based on SINR and decoding error rate. In step 1011, UE1 performs control beam sounding by scanning and detecting control beams of its serving cell and neighboring cells. In step 1012, UE1 then reports detectable control beams to its serving base station BS1. The CB information report may include cell ID, beam ID, strength indication, and can be embedded in measurement report. For example, UE1 reports detectable beams (BS1, CB1) and (BS2, CB4) to BS1. Similarly, in step 1013, UE2 performs control beam sounding by scanning and detecting control beams of its serving cell and neighboring cells. In step 1014, UE2 then reports detectable control beams to its serving base station BS2. The CB information report may include cell ID, beam ID, strength indication, and can be embedded in measurement report. For example, UE2 reports detectable beams (BS1, CB1) and (BS2, CB4) to BS2. After collecting enough CB information reports, individual BSs can re-coordinate (pre-determined or random) CB pattern. For example, BS2 may change its CB pattern based on the reports. In step 1021, BS1 and BS2 exchange and re-coordinate their control beam transmission order via a BS-BS interface (X2). In some scenarios, not all interfering neighboring control beams can be avoided. Based on the reports, some heavy interfering control beams should be prioritized in coordination. Re-coordinated and refined CB transmission information can also be signaled to UEs. In step 1031, BS1 indicates the change of CB pattern at BS2 to UE1. Similarly, in step 1032, BS2 indicates the change of CB pattern at B52 to UE2.

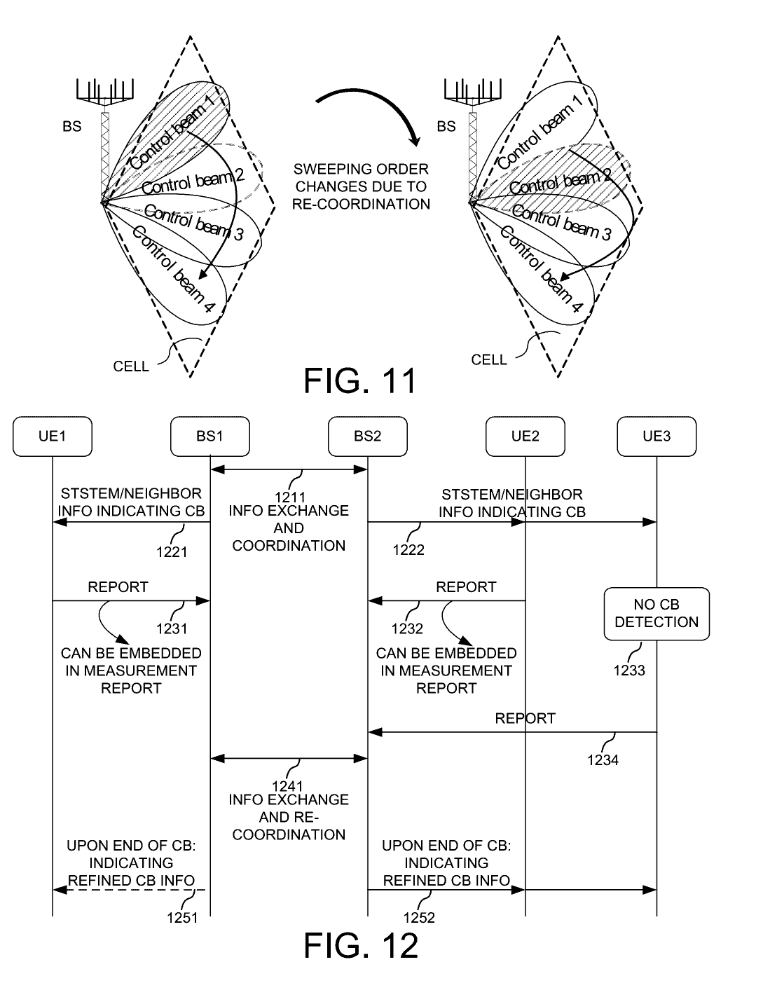

FIG. 11 illustrate an example of inter-BS control beam re-coordination. As illustrated in FIG. 11, a serving BS is configured with a cell covered by four control beams CB1 to CB4. The four control beams have an initial sweeping order of CB1, CB2, CB3, and CB4, occurred periodically in time domain. After collecting enough UE reports of detectable CBs of neighboring cells, BS performs CB re-coordination and changes its sweeping order. The updated CBs have an updated sweeping order of CB2, CB3, CB4, and CB1, occurred periodically in time domain to reduce mutual interference.

FIG. 12 is another signaling flow chart of supporting inter-BS control beam re-coordination. Before changing control beam pattern, BS can signal (part or all) the CB information to the served UEs via dedicated or broadcast signaling. As a result, UEs can avoid searching at the wrong timing for its selected beams. UE-observed interference before and after CB pattern change provides additional information for coordinated cells to resolve beam interference. Furthermore, new BSs joining in a network of existing BSs can utilize the coordination and re-coordination to fit into the network.

In the example of FIG. 12, in step 1211, BS1 and BS2 perform CB information exchange and CB pattern coordination. In step 1221, BS1 transmits system and neighbor information that indicates CB pattern of BS1 and BS2 to its serving UE1. In step 1222, BS2 transmits system and neighbor information that indicates CB pattern of BS1 and BS2 to its serving UE2 and UE3. In step 1231, UE1 performs beam-aware scanning and measurement and then reports detectable CB information to BS1, which can be embedded in measurement report. In step 1232, UE2 performs beam-aware scanning and measurement and then reports detectable CB information to BS2, which can be embedded in measurement report. In step 1233, UE3 does not detect any control beams due to staggering. In step 1234, UE3 reports to BS2 that no control beams are detectable. In step 1241, BS1 and BS2 exchanges CB information and re-coordinates CB pattern based on the collected reports from the UEs (e.g., so UE3 can detect certain CBs). In step 1251, upon the end of CB period, BS1 transmits refined CB information to UE1. In step 1252, upon the end of a CB period, BS2 transmits refined CB information to UE2/UE3.

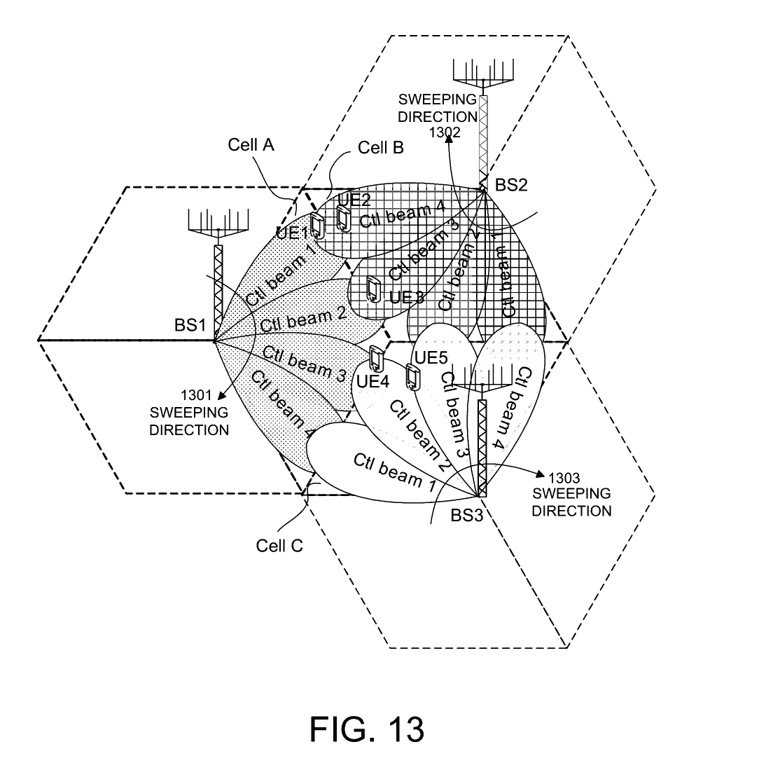

FIG. 13 illustrate one embodiment of staggered BS control beam sweeping direction and order. In the embodiment of FIG. 13, staggered BS control beam sweeping direction and order within synchronous CB period helps in heavy interference. In case of severe mutual interference, a UE cannot resolve any control beam for connection establishment. In order to minimize CB collision probability at the UE, the rotation of CB sweeping direction/order should be “asynchronous” among neighboring BSs. The coordinated neighboring cells CB sweeping direction/order avoids inter-cell interference. For example, at time T1, each cell is on its control beam CB1. Cell A has a sweeping direction depicted by arrow 1301, and Cell B has a sweeping direction depicted by arrow 1302. As a result, UE1 and UE2 are able to detect CB1 in Cell A, and report (cell ID, CBID)=(A, 1) to their serving BS1 and BS2 respectively, and UE3 is able to detect CB2 in Cell A and report (A, 2) to BS2.

When a new BS3 joins the network, BS3 can exchange the CB pattern with BS1 and BS2, and then configure its own control beams with a sweeping direction as depicted by arrow 1303 to minimize mutual interference for UE4 and UE5. Note that inter-BS coordination and change of control beam transmission order should be a rare event, which is preferably applied for a new cell entering a stable network. The new cell may select an initial transmission order randomly or predetermined, and then collect UE feedback for coordination before control beam transmission order is change. After convergent, the mutual interference situation is stable and preferably no transmission order change is conducted.

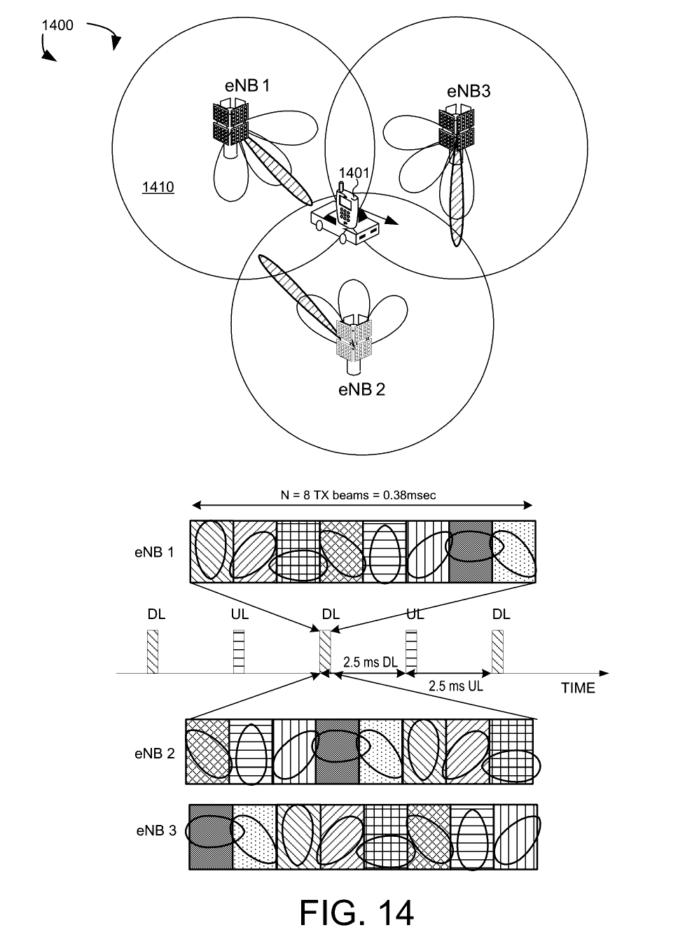

FIG. 14 illustrates UE behavior upon neighbor cell information acquisition in a beamforming mmWave mobile communication network 1400. Beamforming mmWave mobile communication network 1400 comprises a plurality of base stations (eNBs) including a source eNodeB eNB1, a target eNodeB eNB2, and a neighbor eNodeB eNB3 serving a plurality of small cells. User equipment UE 1401 is initially served by source base station eNB1 in smallcell 1410. As illustrated earlier, UE 1401 can be aware that its serving BS and neighboring BSs are using periodic CBs and corresponding CB pattern information. Such information is acquired via BS's advertisement. Such information also reduces UE effort for monitoring neighboring CBs. Given inter-BS coordinated CB pattern, a beam-aware scanning scheme can be applied by UE 1401.

In the example of FIG. 14, the neighboring BSs have synchronized CB periods with staggered sweeping orders as plotted in the bottom half of FIG. 14. Each base station transmits DL or UL control beams CB1-CB8 during the same time interval, but with non-overlapping spatial coverage for each particular control beam. At each UE, in contrast to intra-cell beam alignment, a UE shall scan all level one (L1) control beams of its neighbor cells during the advertised CB periods. For mobility purpose, the UE does not need to scan level two (L2) dedicated data beams of its neighbor cells. Dedicated beam scanning is only necessary for its own serving cell. A complete scanning shall be done to have a robust metrics for handover trigger checking before HO is considered. Note that when making HO decision, the same level of beam measurements (e.g., control beam measurement of neighbor cells vs. control beam measurement of serving cell) are compared. In addition, the UE triggers scanning only during known active CB period as advertised by the serving BS to avoid blind scanning and achieve reduced UE efforts.

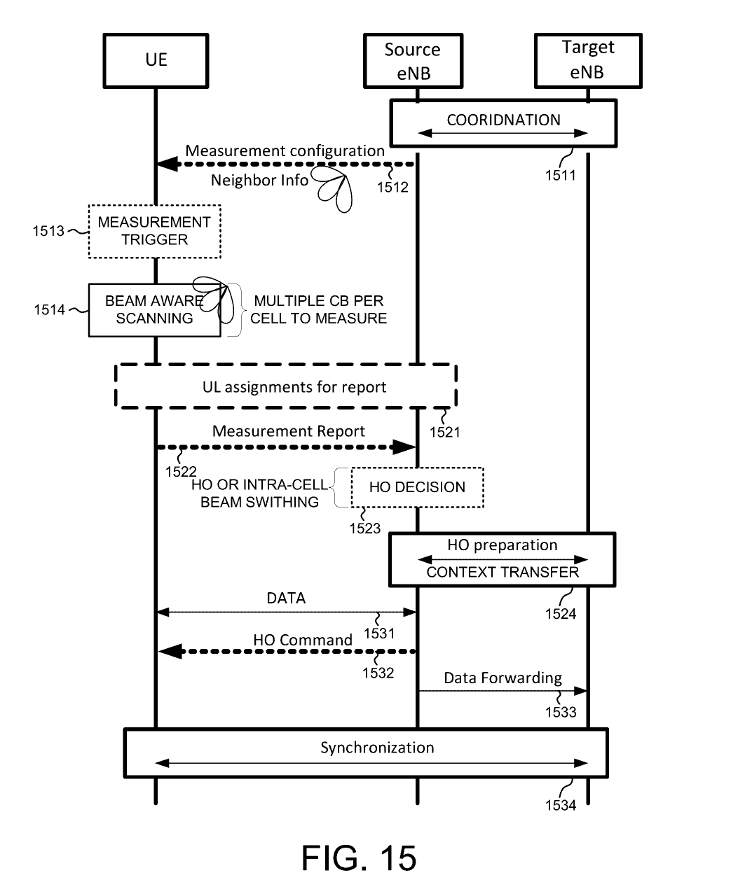

FIG. 15 illustrates one embodiment of beam-aware scanning and measurement reporting after inter-BS control beam coordination and receiving neighbor cell information advertisement. A UE is served by a source eNB in a source cell of a beamforming mmWave network. In step 1511, the source eNB and a target eNB performs control beam coordination and determines their CB transmissions accordingly to reduce inter-cell interference. In step 1512, the source eNB transmits measurement configuration to the UE. In addition, the source eNB also transmits serving cell and neighbor cell control beam information advertisement to the UE, which includes CB synchronicity, CB periodicity, and CB pattern. Based on the measurement configuration, the UE triggers measurements in step 1513. The measurement trigger would be similar to LTE mobility. For example, as in S-measure and R criteria, a neighboring cell RSRP is measured when the serving cell RSRP is worse than a threshold.

In step 1514, the UE performs beam-aware scanning based on the control beam information advertisement received in step 1512. Under beam-aware scanning, the UE can avoid blind scanning and unnecessary HO. The UE performs a complete scanning on all L1 control beams of its neighbor cells during the advertised CB periods. The UE monitors the channel quality of each control beam of each cell. In one embodiment, the UE measures the cell specific measurement target (CSMT) based on the channel quality of all L1 control beams of each neighboring cell Xn:

CSMT_n=max_i{CSMT_Xn_i, for all i}

where
n=1, 2, 3 . . . is the cell ID
i is the control beam index of cell n

For example, CSMT can be Reference Signal Received Power (RSRP) or Reference Signal Received Quality (RSRQ) defined in LTE. Note that the “max’ rule in the above equation allows the UE to find a properly mobility measurement metric based on all control beams. This rule avoids unnecessary HO, e.g., due to degradation of a single L1 control beams, which could be handled by intra-cell beam switching to another control beam in the same serving cell. Instead of the “max” rule, in another embodiment, the UE uses an average channel quality of the strongest control beam of the cell during a CB period, whose strength have fulfilled certain lower threshold. In addition to channel quality, other UE context information including UE location information can be obtained and reports to the base station for HO decision.

In step 1521, the UE receives UL assignment/grant for measurement report. In step 1522, the UE sends the measurement report to the source eNB. In step 1523, the source eNB makes HO decision or intra-cell beam switching decision based on the measurement report. If handover is decided, then in step 1524, the source eNB and the target eNB performs HO preparation and context transfer. In step 1531, the UE and the source eNB continue to exchange UE data before HO. In step 1532, the source eNB sends an HO command to the UE. In step 1533, the source eNB forwards the UE data to the target eNB. Finally, in step 1534, the UE performs synchronization with the target eNB and is handed over to the target eNB.

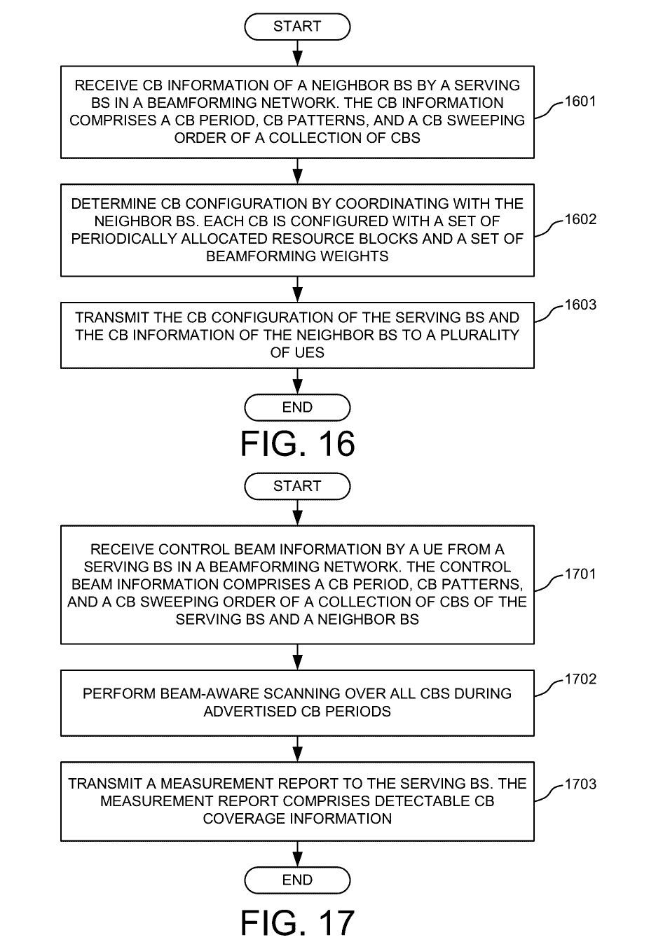

FIG. 16 is a flow chart of a method of providing inter-BS control beam coordination and neighbor cell information advertisement in a beamformed mmWave smallcell in accordance with one novel aspect. In step 1601, a serving base station receives control beam information of a neighbor base station in the beamformed mmWave smallcell. The CB information comprises a CB period, CB patterns, and CB sweeping order of a collection of control beams. In step 1602, the serving BS determines CB configuration by coordinating with the neighbor BS. Each control beam is configured with a set of periodically allocated resource blocks and a set of beamforming weights. In step 1603, the serving BS transmits the CB configuration of the serving BS and the CB information of the neighbor BS to a plurality of user equipments (UEs).

FIG. 17 is a flow chart of a method of beam-aware scanning and measurement reporting in a beamformed mmWave smallcell in accordance with one novel aspect. In step 1701, a user equipment (UE) receives control beam information from a serving base station in the beamformed mmWave smallcell. The CB information comprises a CB period, CB patterns, and a CB sweeping order of a collection of control beams of the serving BS and a neighbor BS. In step 1702, the UE performs beam-aware scanning over all control beams during advertised CB periods. In step 1703, the UE transmits a measurement report to the serving BS. The measurement report comprises detectable CB coverage information.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving control beam (CB) information of a neighbor base station by a serving base station in a beamforming mobile communication network, wherein the control beam information comprises a CB period, CB patterns, and a CB sweeping order for a collection of CBs of the neighbor base station;
determining CB configuration by coordinating with the neighbor base station, wherein each CB is configured with a set of periodically allocated resource blocks and a set of beamforming weights; and
transmitting the CB configuration of the serving base station and the CB information of the neighbor base station to a plurality of user equipments (UEs).

2. The method of claim 1, wherein the collection of the CBs create a radiation pattern that covers an entire service area of a cell.

3. The method of claim 1, wherein the CB information is with respect to a common reference.

4. The method of claim 1, wherein CB transmissions from different cells have non-overlapping CB periods in time domain.

5. The method of claim 1, wherein CB transmissions from different cells have overlapping CB periods in time domain and non-overlapping spatial coverage.

6. The method of claim 1, wherein the coordinating involves determining a sweeping order of the different CB patterns to reduce spatial interference among the CB transmissions from the different cells.

7. The method of claim 1, further comprising:
receiving measurement reports from the plurality of UEs, wherein the measurement reports comprises detectable CB coverage information.

8. The method of claim 7, further comprising:
performing re-coordination with the neighbor base station based on the measurement reports.

9. The method of claim 7, further comprising:
determining whether to perform inter-cell handover or intra-cell beam switching based on the measurement reports.

10. A method, comprising:
receiving control beam (CB) information by a user equipment (UE) from a serving base station in a beamforming mobile communication network, wherein the control beam information comprises a CB period, CB patterns, and a CB sweeping order of a collection of CBs of the serving base station and a neighbor base station;
performing beam-aware scanning over all CBs during advertised CB periods;
transmitting a measurement report to the serving base station, wherein the measurement report comprises detectable CB coverage information.

11. The method of claim 10, wherein the UE triggers the measurement reporting based on control beam measurements.

12. The method of claim 10, wherein the beam-aware scanning involves triggering scanning only during active CB periods as advertised by the base station.

13. The method of claim 10, wherein the beam-aware scanning involves monitoring a channel quality of each control beam of each cell.

14. The method of claim 13, wherein the UE measures a cell-specific measurement target (CSMT) based on the channel quality of all control beams of each cell.

15. The method of claim 14, wherein the CSMT of a cell indicates a maximum channel quality among all control beams of the cell during a CB period.

16. The method of claim 14, wherein the CSMT of a cell indicates an average channel quality of a strongest control beam of the cell during a CB period.

17. The method of claim 13, wherein the UE obtains location information during the beam-aware scanning and reports to the serving base station.

18. A user equipment (UE), comprising:
a receiver that receives control beam information by a user equipment from a serving base station in a beamforming mobile communication network, wherein the control beam information comprises a CB period, CB patterns , and a CB sweeping order of a collection of CBs of the serving base station and a neighbor base station;
a measurement module that performs beam-aware scanning over all CBs during advertised CB periods;
a transmitter that transmits a measurement report to the serving base station, wherein the measurement report comprises detectable CB coverage information.

19. The UE of claim 18, wherein the UE triggers the measurement reporting based on control beam measurements excluding dedicated beam measurements.

20. The UE of claim 18, wherein the beam-aware scanning involves triggering scanning only during active CB periods as advertised by the base station.

21. The UE of claim 18, wherein the beam-aware scanning involves monitoring a channel quality of each control beam of each cell.

22. The UE of claim 18, wherein the UE measures a cell-specific measurement target (CSMT) based on the channel quality of all control beams of each cell.

23. The UE of claim 22, wherein the CSMT of a cell indicates a maximum channel quality among all control beams of the cell during a CB period.

24. The UE of claim 22, wherein the CSMT of a cell indicates an average channel quality of a strongest control beam of the cell during a CB period.

25. The UE of claim 21, wherein the UE obtains location information during the beam-aware scanning and reports to the serving base station.
